(19) United States
(12) Patent Application Publication
(10) Pub. No.: US 2009/0015510 A1
(43) Pub. Date: Jan. 15, 2009

(54) ANTENNA

(76) Inventors: Daisuke NAKATA, Okayama (JP); Hideto Sadamori, Okayama (JP)

Correspondence Address: MCDERMOTT WILL & EMERY LLP, 600 13TH STREET, NW, WASHINGTON, DC, 20005-3096, US

(21) Appl. No.: 12/171,553

(22) Filed: Jul. 11, 2008

(30) Foreign Application Priority Data
Jul. 11, 2007 (JP) 2007-181931

(51) Int. Cl. H01Q 1/12

(52) U.S. Cl. 343/878

(57) ABSTRACT

An antenna includes an antenna element having a belt-shaped tip of which edge is chamfered at two corners, and the belt-shaped tip has a rectangular stopper hole at its width center. The antenna includes a base on which a pedestal is formed corresponding to the belt-shaped tip. The pedestal is provided with an arched protrusion shaped like letter “U” so that an insertion slit slightly greater than the belt-shaped tip in width and thickness can be formed. A stopper protrusion is formed on an inner wall of the arched protrusion such that it corresponds to the stopper hole. The belt-shaped tip is inserted into the slit with ease, and the stopper hole mates with the stopper protrusion, thereby fixing the antenna element to the base in a simple manner.

### FIELD OF THE INVENTION

The present invention relates to a compact antenna built in a variety of communication devices such as cell phones.

### BACKGROUND OF THE INVENTION

A conventional antenna built in a variety of communication devices such as cell phones is described hereinafter with reference to FIG. 7-FIG. 11. FIG. 7 is a perspective drawing of the conventional antenna viewed from the top. FIG. 8 is a perspective drawing of the conventional antenna viewed from the bottom. FIG. 9 is a perspective drawing of a base of the antenna viewed from the bottom. FIG. 10 is a perspective drawing of an antenna element, viewed from the bottom, of the conventional antenna. FIG. 11 is a sectional drawing of the conventional antenna cut along line 11-11 in FIG. 7.

As shown in FIG. 7, antenna element 2 made of thin metal sheet is fixed to box-shaped base 1 made of insulating resin. Box-shaped base 1 is open at its bottom. Base 1 includes protrusion 1b on its top face 1a at 6 places and on pedestal 1d at one place. These protrusions 1b are used for riveting. Pedestal 1d is shown in FIGS. 8, 9 and formed on the underside of base 1 within the opening.

Antenna main section 2a of antenna element 2 is laid out on one plane so that it has a given resonance frequency characteristics, and includes riveting hole 2b at 6 places to mate protrusions 1b formed on top face 1a at 6 places. Protrusions 1b mated with holes 2b are riveted (crushed) so that antenna main section 2a is fixed to base 1. Belt-shaped tip 2c extending like a belt from the end of antenna main section 2a of antenna element 2 is used for electrically connecting to a circuit of an electronic device (not shown). This belt-shaped tip 2c extends via lateral wall 1c of base 1 to pedestal 1d formed on the underside of base 1. Protrusion 1b formed on pedestal 1d is mated with riveting hole 2b formed on the end of belt-shaped tip 2c and then riveted for fixing belt-shaped tip 2c to pedestal 1d. In other words, as shown in FIG. 10, belt-shaped tip 2c of antenna element 2 forms letter “L” extending from the plane forming antenna main section 2a.

A method of manufacturing the antenna thus constructed includes the following steps: Firstly, approach antenna element 2 shown in FIG. 10 to base 1 along the lateral direction as shown in FIG. 9, and then mate the riveting hole 2b of belt-shaped tip 2c with protrusion 1b formed on pedestal 1d of base 1. Next, mate the riveting holes 2b formed on antenna main section 2a at six places with protrusions 1b formed on top face 1a at six places. Antenna element 2 is thus tentatively mounted to base 1 in order to prevent antenna element 2 from coming off base 1. Then rivet the protrusions 1b formed on top face 1a and pedestal 1d of base 1 so that antenna element 2 is fixed to base 1.

Known related art to the present invention is, e.g. Unexamined Japanese Patent Publication No. 2002-344233.

The conventional antenna discussed above is formed of antenna element 2 fixed to the surface of base 1 through riveting protrusions 1b provided both to top face 1a and pedestal 1d formed on the underside within the opening as shown in FIG. 11. However, protrusions 1b at six places on top face 1a are riveted (crushed) simultaneously with protrusion 1b on pedestal 1d. This simultaneous riveting prevents the manufacturing method of the antenna from increasing the efficiency. Because top face 1a has six protrusions 1b while pedestal 1d has one protrusion 1b, and this difference is so great that a riveter needs to be finely adjusted in order to rivet all the protrusions well-balanced.

It is difficult to raise a riveting speed with the riveter finely adjusted, so that a user cannot expect a considerable increase in the riveting speed. As a result, the structure discussed above prevents the conventional antenna from being manufactured more efficiently.

### SUMMARY OF INVENTION

The present invention addresses the foregoing problem, and aims to provide an antenna that allows its antenna element to be fixed to the base with ease, and the antenna of the present invention can be thus efficiently manufactured. To achieve this objective, the antenna of the present invention has the following structure:

The antenna element made of thin metal sheet is mounted in a continuous form onto a first face (principal face) and a second face of a base made of resin. The first and the second faces of the base confront each other. The tip of the antenna element is mounted to the second face of the base, and the tip is shaped like a belt having a stopper hole at the end of the belt. The second face of the base includes an arched protrusion having an insertion slit, into which the belt-shaped tip can be inserted along the direction parallel to the second face. The arched protrusion has a stopper protrusion, with which the stopper hole of the antenna element mates, on the inner wall of the insertion slit. When the belt-shaped tip is inserted into the insertion slit, the stopper protrusion mates with the stopper hole for fixing the belt-shaped tip to the base. This structure is a feature of the antenna of the present invention.

The structure of the antenna of the present invention allows the belt-shaped tip to be fixed to the base only by inserting the belt-shaped tip into the insertion slit. As a result, riveting or crushing the protrusions formed on the first surface of the base allows fixing the antenna element to the base. Thus the antenna of the present invention can be manufactured efficiently.

As discussed above, the antenna element is placed both on the first face and the second face of the base with the faces confronting each other, and the antenna element includes the belt-shaped tip mounted to the second surface of the base. The belt-shaped tip has a stopper hole and is inserted into an insertion slit of which inner wall has a stopper protrusion. This structure allows the antenna element placed both on the first and second faces of the base to be mounted to the base with ease, so that the antenna can be manufactured efficiently.

### BRIEF DESCRIPTION OF THE DRAWINGS

FIG. 1 shows a sectional view of an antenna, in accordance with a first embodiment of the present invention, cut along line 1-1 in FIG. 2.

FIG. 2 is a perspective drawing of the antenna, viewed from the top, in accordance with the first embodiment of the present invention.

FIG. 3 is a perspective drawing of the antenna, viewed from the bottom, in accordance with the first embodiment of the present invention.

FIG. 4 is a perspective drawing of an antenna element, viewed from the bottom, in accordance with the first embodiment of the present invention.

FIG. 5 shows a plan view of a base in accordance with the first embodiment of the present invention.

FIG. 6 is a perspective drawing of the base, viewed from the bottom, in accordance with the first embodiment of the present invention.

FIG. 7 is a perspective drawing of a conventional antenna viewed from the top.

FIG. 8 is a perspective drawing of the conventional antenna viewed from the bottom.

FIG. 9 is a perspective drawing of a base, viewed from the bottom, of the conventional antenna.

FIG. 10 is a perspective drawing of an antenna element, viewed from the bottom, of the conventional antenna.

FIG. 11 shows a sectional view of the conventional antenna cut along line 11-11 in FIG. 7.

### DESCRIPTION OF PREFERRED EMBODIMENT

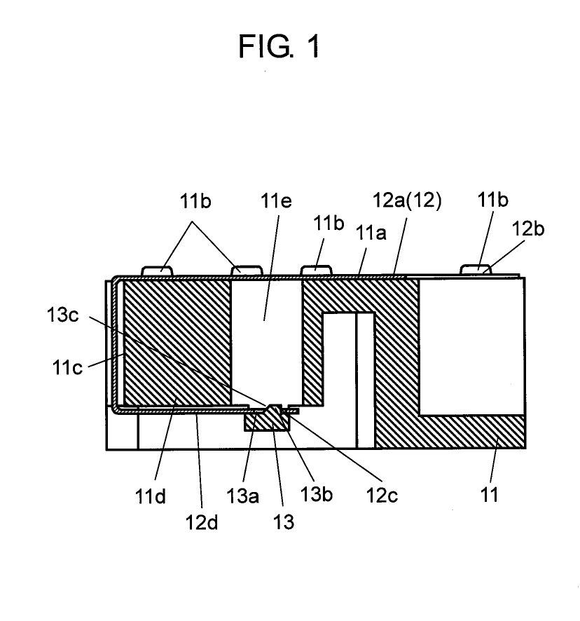

An exemplary embodiment of the present invention is demonstrated hereinafter with reference to FIG. 1-FIG. 6. In these drawings, dimensions are enlarged for a clearer description of the structure. Similar elements to those in other drawings have the same reference marks, and the descriptions thereof are sometimes omitted.

### First Embodiment

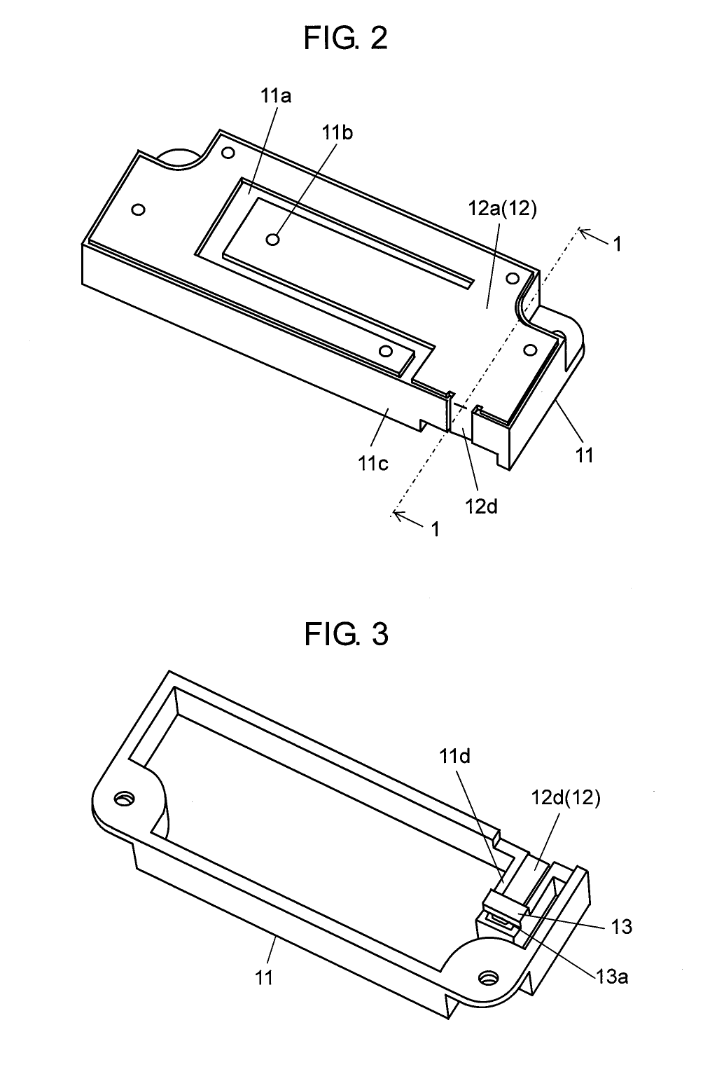

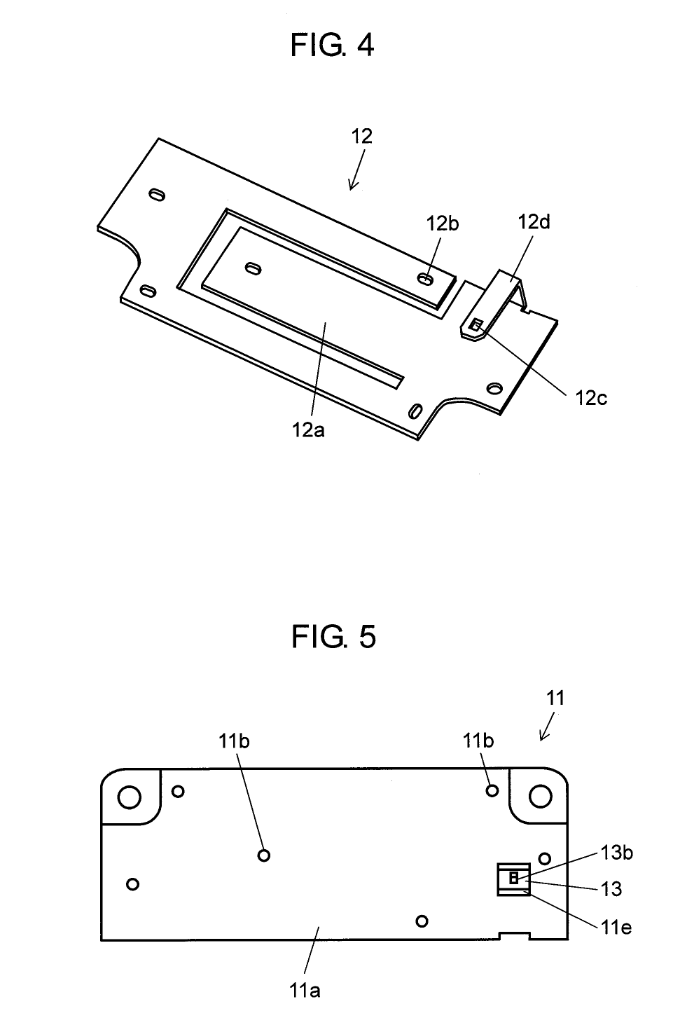

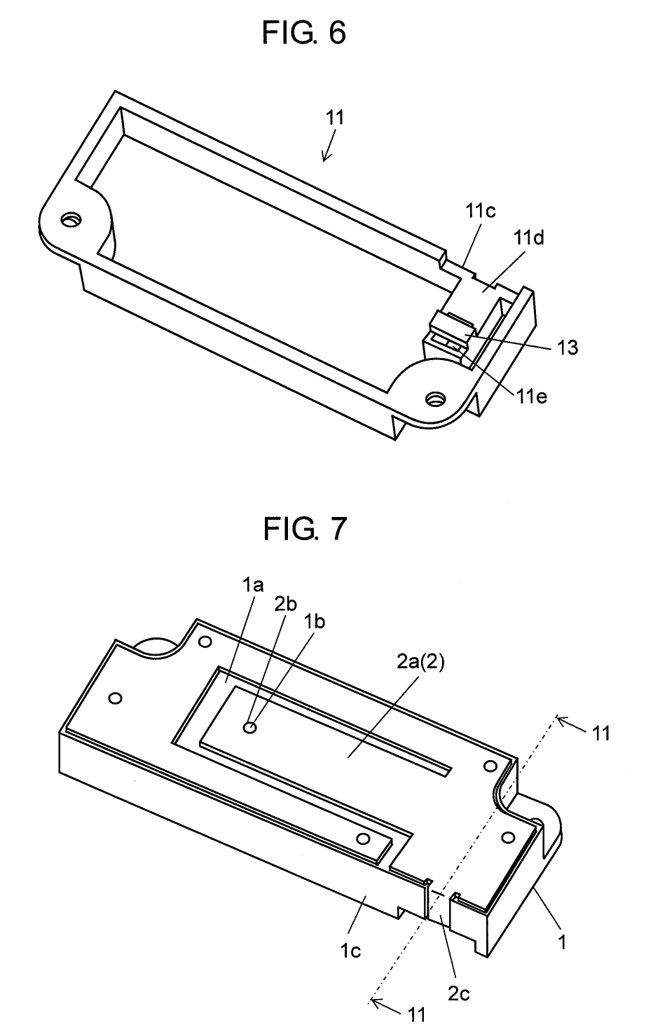

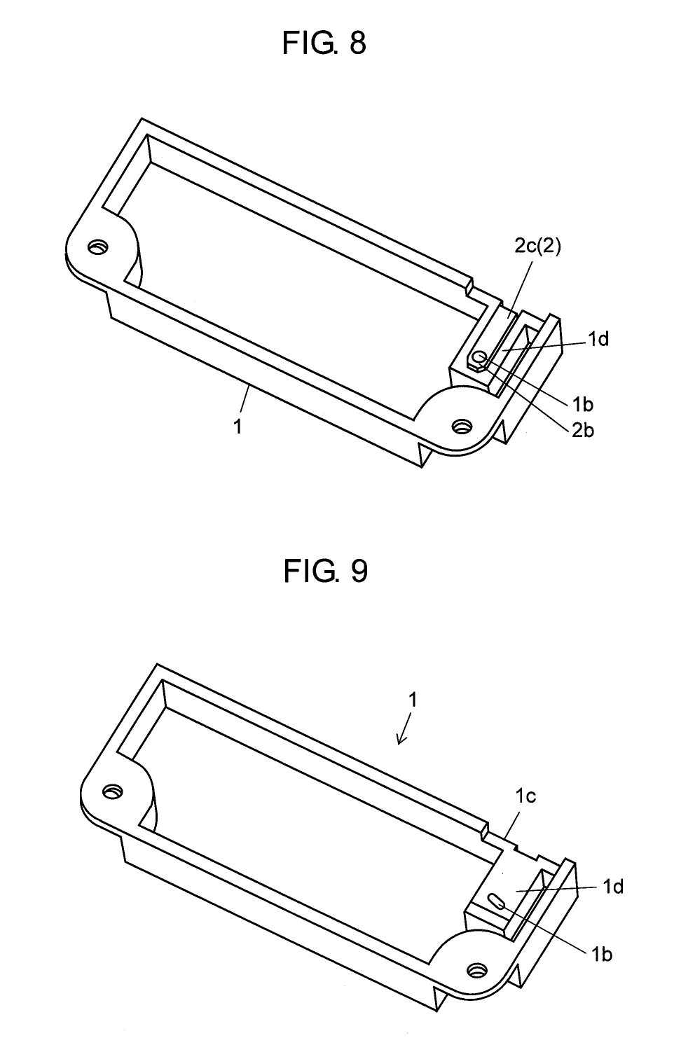

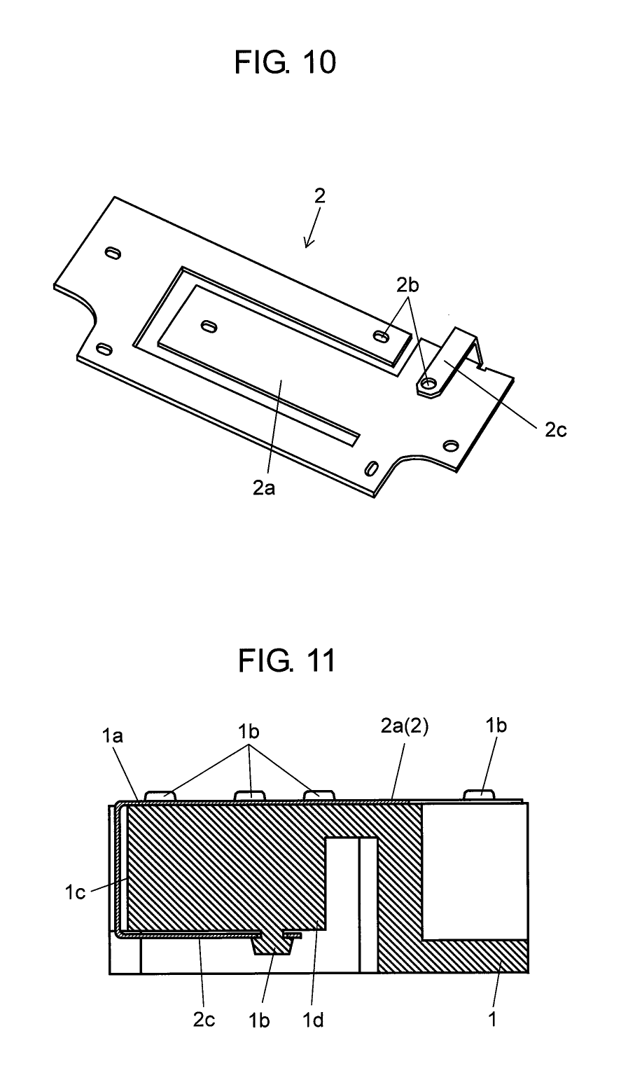

FIG. 1 shows a sectional view of an antenna, in accordance with the first embodiment of the present invention, cut along line 1-1 in FIG. 2. FIG. 2 is a perspective drawing of the antenna viewed from the top. FIG. 3 is a perspective drawing of the antenna viewed from the bottom. FIG. 4 is a perspective drawing of an antenna element viewed from the bottom. FIG. 5 shows a plan view of a base. FIG. 6 is a perspective drawing of the base viewed from the bottom.

As shown in FIG. 1-FIG. 6, the antenna of the present invention has the following structure: a box-shaped base 11 made of insulating resin is open at its bottom, and antenna element 12 made of thin metal sheet is mounted on both of the faces, confronting each other, of base 11. To be more specific, riveting protrusions 11b formed on top face 11a of base 11 at six places are riveted (crushed) so that antenna main section 12a of antenna element 12 is fixed to base 11. Antenna main section 12a is laid out within top face 11a such that it has predetermined resonance frequency characteristics, and includes riveting holes 12b at six places corresponding to riveting protrusions 11b.

Antenna element 12 includes belt-shaped tip 12d extending like a belt from the end of antenna main section 12a. Belt-shaped tip 12d is used for electrically connecting to a circuit of an electronic device (not shown). This belt-shaped tip 12d extends via lateral wall 11c of base 11 to pedestal 11d protruded from the underside of base 11 and within the opening, and tip 12c is fixed to pedestal 11d.

Belt-shaped tip 12d of antenna element 12 is bent such that it crosses antenna main section 12a at right angles, and further bent at the height of base 11 at right angles such that it confronts antenna main section 12a. The edge of belt-shaped tip 12d is chamfered at its two corners, and has a rectangular stopper hole 12c at the center along the width direction.

Pedestal 11d corresponding to belt-shaped tip 12d has insertion slit 13a slightly greater than the plate-like belt-shaped tip 12d in width and thickness as shown in FIG. 1 and FIG. 3. Belt-shaped tip 12c can be thus inserted into insertion slit 13a. Besides insertion slit 13a, pedestal 11d also includes arched protrusion 13 protruded downward like letter “U” from the surface of pedestal 11d.

On the inner wall of insertion slit 13a of arched protrusion 13, stopper protrusion 13b is formed as shown in FIG. 1 and FIG. 5 as the counterpart of stopper hole 12c formed on belt-shaped tip 12d. Stopper protrusion 13b is rectangular so that it can mate with rectangular stopper hole 12c. Slope 13c is formed before stopper protrusion 13b so that belt-shaped tip 12d can be smoothly inserted along slope 13c into insertion slit 13a.

In this embodiment, since base 11 molded of resin is used, base 11 is provided with through-hole 11e extending from top face 11a to pedestal 11d in order to form arched protrusion 13. Use of through-hole 11e is preferable because this structure allows forming arched protrusion 13 having stopper protrusion 13b with a simple metal mold.

A method of manufacturing the antenna thus constructed includes the following steps: Firstly, approach antenna element 12 shown in FIG. 4 to base 11 shown in FIG. 6, and then insert the edge of belt-shaped tip 12d slidingly into insertion slit 13a along the direction parallel to the surface of pedestal 11d of base 11. Since the corners of the edge of belt-shaped tip 12d are chamfered, the corners guide belt-shaped tip 12d into insertion slit 13a smoothly, so that the insertion can be done efficiently. Insertion of belt-shaped tip 12d further in depth into insertion slit 13a bows belt-shaped tip 12c along slope 13c, and belt-shaped tip 12d runs up slidingly onto stopper protrusion 13b. When the edge of belt-shaped tip 12d runs over stopper protrusion 13b, and stopper hole 12c agrees with stopper protrusion 13b, then elastic modulus works such that stopper hole 12c mates with stopper protrusion 13b. Belt-shaped tip 12d is thus accommodated flat in insertion slit 13a with stopper hole 12c mating with stopper protrusion 13b. In this status, belt-shaped tip 12d cannot be pulled out from insertion slit 13a, and thus the position of belt-shaped tip 12d is fixed to base 11 as shown in FIG. 1.

Then mate the riveting holes 12b of main section 12a of antenna element 12 with riveting protrusions 11b formed on top face 11a, and rivet or crush riveting protrusions 11b at six places for fixing antenna element 12 to base 11.

Immediately after the mating of stopper hole 12c of belt-shaped tip 12d with stopper protrusion 13b, riveting protrusions 11b on top face 11a mate with riveting holes 12b of antenna main section 12a. Antenna element 12 is thus assembled with base 11 almost simultaneously with the mating of stopper holes 12c with riveting protrusions 11b at the six places. Then riveting protrusions 11b on top face 11a at the six places are riveted (crushed) at the same time for completing the manufacture of the antenna.

In this embodiment, base 11 is provided with through-hole 11e extending from top face 11a to pedestal 11d; however, the present invention is not limited to this example. For instance, here is another idea: devising a shape of pedestal 11d or arched protrusion 13 for avoiding a press-fit status between belt-shaped tip 12d and pedestal 11d when belt-shaped tip 12d runs up over stopper protrusion 13b. Depending on a shape of pedestal 11d or a shape of arched protrusion 13, belt-shaped tip 12d can be thus regulated its position along, e.g. the vertical direction with respect to the insertion direction. This structure allows belt-shaped tip 12d to be inserted efficiently and smoothly into insertion slit 13a, and allows stopper hole 12c to be mated quickly with stopper protrusion 13b with ease. Besides the examples discussed in this embodiment, arched protrusion 13 having stopper protrusion 13b can be formed by assembling multiple components.

As discussed above, the embodiment tells that a continuous form of antenna element 12 is placed on the faces, confronting each other, of base 11 and antenna element 12 is fixed to the respective faces to form the antenna. This structure allows incorporating antenna element 12 into base 11 with ease, and allows antenna element 12 to be fixed to base 11 by riveting the protrusions 11b only on top face 11a of base 11. The antenna of the present invention can be thus assembled with ease and efficiently.

The antenna of the present invention allows its antenna element to be fixed with ease to the base at both faces, confronting each other, of the base, so that efficient manufacture of the antenna can be expected. The antenna of the present invention is thus useful to the communication devices including cell phones.

What is claimed is:

1. An antenna comprising:
an antenna element made of thin metal sheet; and
a base made of resin having a first face and a second face confronting each other;
wherein the antenna element is disposed in a continuous form on the first face and the second face of the base,
wherein the antenna element disposed on the first face has an end of which tip is shaped like a belt and has a stopper hole near an edge of the tip,
wherein the belt-shaped tip is disposed on the second face of the base, and the second face includes an arched protrusion having an insertion slit into which the belt-shaped tip can be inserted along a direction parallel to a surface of the second face, and the insertion slit has a riveting protrusion on an inner wall of the slit, and the stopper protrusion mates with the stopper hole of the antenna element, and
wherein when the belt-shaped tip is inserted into the slit, the stopper protrusion mates with the stopper hole for fixing the belt-shaped tip to the base.
